(19) United States
(12) Patent Application Publication
(10) Pub. No.: US 2026/0177084 A1
(43) Pub. Date: Jun. 25, 2026

(54) Rotary Actuator with a Position Sensor

(71) Applicant: Parker-Hannifin Corporation, Cleveland, OH (US)

(72) Inventors: Scott E. Neel, Lake Tapps, WA (US); Travis M. Perry, Auburn, WA (US)

(21) Appl. No.: 19/132,469

(22) PCT Filed: Nov. 27, 2023
(86) PCT No.: PCT/US2023/081134

§ 371 Date: May 23, 2025

Related U.S. Application Data
(60) Provisional application No. 63/428,741, filed on Nov. 30, 2022.
(60) Provisional application No. 63/495,589, filed on Apr. 12, 2023.

(51) Int. Cl. F15B 15/28; G01D 5/02

(52) U.S. Cl. CPC F15B 15/2815; G01D 5/02; G01D 2205/22

(57) ABSTRACT

An example rotary actuator includes: a housing having a cavity therein; an output shaft disposed in the cavity and configured to rotate within the housing upon providing fluid flow within the housing; a cam coupled to the output shaft and configured to rotate therewith; and a rotary′ sensor mounted to the housing, wherein the rotary′ sensor interacts with the cam such that the rotary sensor provides sensor information indicating a rotary′ position of the cam and the output shaft.

### CROSS REFERENCE TO RELATED APPLICATION

The present application claims priority to U.S. Provisional Application No. 63/428,741 filed on Nov. 30, 2022 and U.S. Provisional Application No. 63/495,589 filed on Apr. 12, 2023, the entire contents of all of which are herein incorporated by reference as if fully set forth in this description.

### BACKGROUND

Some rotary actuators involve using high pressure fluid to cause rotation of an output shaft. Such rotary actuators can be exposed to high moment, thrust, and radial loading because they are designed to be part of the structural load path in most applications.

In some applications, it may be desirable to measure the rotary position of the output shaft of a rotary actuator. However, standard encoders and position sensors are not designed to take the loading that the rotary actuator can be subjected to, and therefore such sensors cannot be placed in high load situations without additional support structure and space to operate.

It may thus be desirable to integrate a sensor within the pressure cavity of a rotary actuator to remove the sensor from the external loading. However, exposing the sensor to high pressure levels (e.g., 5000 pounds per square inch) creates additional barriers to the use of some sensors.

It may thus be desirable to have a position sensor configured to measure accurately the rotary position of an output shaft of a rotary actuator without regard to operational pressures in the actuator, external conditions, or internal loads under which the rotary actuator is operating. It is with respect to these and other considerations that the disclosure made herein is presented.

### SUMMARY

The present disclosure describes implementations that relate to a rotary actuator with a position sensor.

In a first example implementation, the present disclosure describes a rotary actuator including: a housing having a cavity therein; an output shaft disposed in the cavity and configured to rotate within the housing upon providing fluid flow within the housing; a cam coupled to the output shaft and configured to rotate therewith; and a rotary sensor mounted to the housing, wherein the rotary sensor interacts with the cam such that the rotary sensor provides sensor information indicating a rotary position of the cam and the output shaft.

In a second example implementation, the present disclosure also describes a method of operating the rotary actuator of the first example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a perspective view of a rotary actuator, according to an example implementation.

FIG. 2 illustrates a side view of the rotary actuator of FIG. 1, according to an example implementation.

FIG. 3 illustrates a front view of the rotary actuator of FIG. 1, according to an example implementation.

FIG. 4A illustrates a perspective view of a rotary sensor, according to an example implementation.

FIG. 4B illustrates a top view of the rotary sensor of FIG. 4A, according to an example implementation.

FIG. 4C illustrates a cross-sectional view of the rotary sensor of FIGS. 4A-4B, according to an example implementation.

FIG. 5 illustrates a cross-sectional side view of the rotary actuator of FIGS. 1-3, according to an example implementation.

FIG. 6 illustrates a perspective view of an end cap, according to an example implementation.

FIG. 7A illustrates a cross-sectional front view of the rotary actuator of FIGS. 1-3 when a follower of a rotary sensor is at a highest position, according to an example implementation.

FIG. 7B illustrates a detailed view of the cross section of FIG. 7A, according to an example implementation according to an example implementation.

FIG. 8A illustrates a cross-sectional front view of the rotary actuator of FIGS. 1-3 when a follower of a rotary sensor is at a mid-rotation position, according to an example implementation.

FIG. 8B illustrates a detailed view of the cross section of FIG. 8A, according to an example implementation.

FIG. 9A illustrates a cross-sectional front view of the rotary actuator of FIGS. 1-3 when a follower of a rotary sensor is at a lowest position, according to an example implementation.

FIG. 9B illustrates a detailed view of the cross section of FIG. 9A, according to an example implementation.

FIG. 10 illustrates another cross-sectional side view of the rotary actuator of FIGS. 1-3, according to an example implementation.

FIG. 11 illustrates a cross-sectional side view of a rotary actuator, according to an example implementation

FIG. 12 is a flowchart of a method for operating a rotary actuator, according to an example implementation.

### DETAILED DESCRIPTION

Disclosed herein are rotary sensors that can operate within a pressure vessel of a rotary actuator. The rotary sensor has a follower that interacts with (e.g., traces) a cam surface mounted to an output shaft of the rotary actuator within the pressure vessel such that rotary position of the output shaft corresponds to a linear position of the follower.

In some examples, a second rotary sensor can be used to compensate for any distortions or radial “play” due to manufacturing tolerances or radial loads that could displace the internal components of the rotary actuator. For instance, such second sensor can have a respective follower that interacts with (e.g., traces) a circular surface, which is concentric with the output shaft. Thus, any radial play in the output shaft can be detected by the respective follower and measured by the second rotary sensor. Such measurement can be subtracted from the measurement of the first or primary sensor, thereby providing a more accurate measurement of the rotary position of the output shaft.

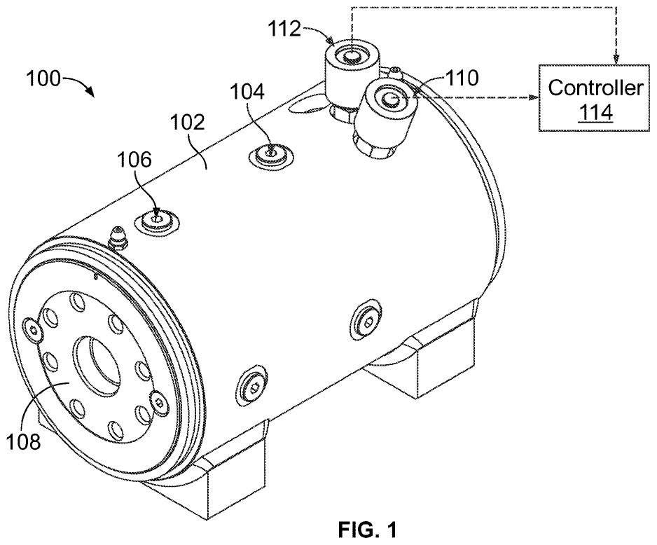

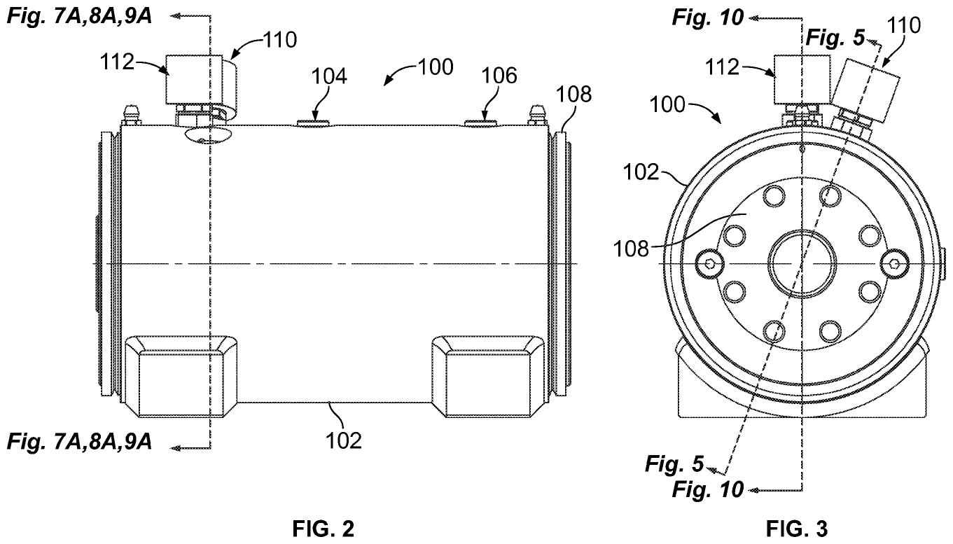

FIG. 1 illustrates a perspective view of a rotary actuator 100, FIG. 2 illustrates a side view of the rotary actuator 100, and FIG. 3 illustrates a front view of the rotary actuator 100, according to an example implementation. FIGS. 1-3 are described together.

The rotary actuator 100 includes a housing 102. The housing 102 operates as a pressure vessel or enclosure for the rotary actuator 100.

The housing 102 can have a plurality of ports such as first port 104 and second port 106 that is axially spaced from the first port 104 along a length of the housing 102. The first port 104 and the second port 106 are configured to receive and discharge fluid (e.g., hydraulic fluid or gas). As described below, fluid provided to the first port 104 or the second port 106 can cause rotation of an output shaft 108 disposed longitudinally within the housing 102. The housing 102 is thus configured as a pressure vessel that can be filled with high pressure fluid, e.g., fluid having pressure level up to 5000 pounds per square inch (psi).

The rotary actuator 100 includes a rotary sensor 110 mounted to the housing 102. As described below, the rotary sensor 110 extends within a cavity of the housing 102 and has a tracer or follower. In one example implementation, the follower can be exposed to the high pressure fluid within the cavity. In another example implementation, the follower can be protected from the high pressure fluid.

In some example implementations, the rotary actuator 100 may include another rotary sensor 112. The rotary sensor 112 is configured to provide a reference measurement that can be used to modify or adjust the measurement of the rotary sensor 110 to compensate for any distortions resulting from manufacturing tolerances or radial loads. In these examples, the rotary sensor 110 can be considered as a primary rotary sensor, while the rotary sensor 112 can be considered as a secondary or reference rotary sensor.

A controller 114 can receive sensor information from the rotary sensor 110 to determine a rotary position of the output shaft 108 as described in more detail below. The controller 114 can include one or more processors or microprocessors and may include data storage (e.g., memory, transitory computer-readable medium, non-transitory computer-readable medium, etc.). The data storage may have stored thereon instructions that, when executed by the one or more processors of the controller 114, cause the controller 114 to perform operations described herein.

The controller 114 can also receive respective sensor information from the rotary sensor 112 to adjust the rotary position of the output shaft 108 determined based on the sensor information of the rotary sensor 110 to compensate for manufacturing tolerances or radial loads as described below. In other examples, the electronics of the rotary sensor 110 or the rotary sensor 112 may perform the operations of the controller 114.

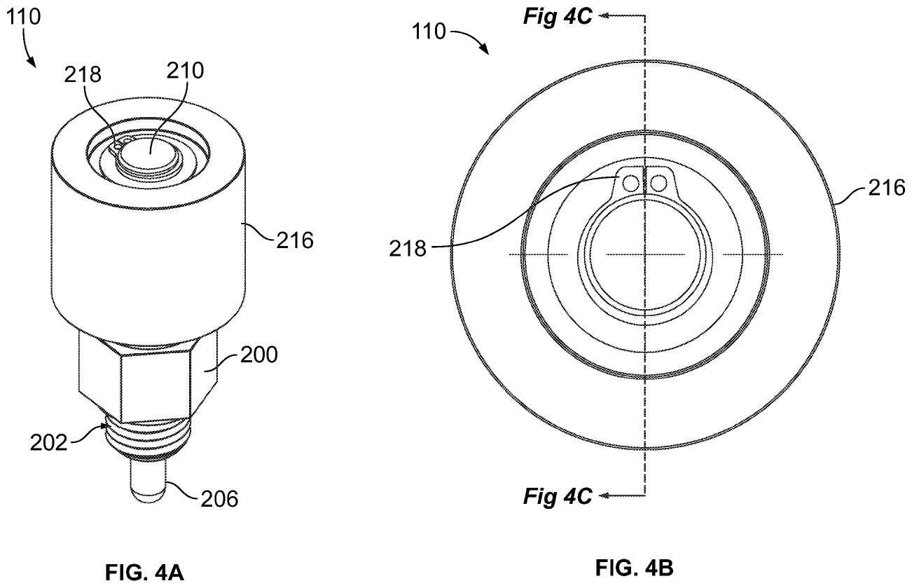

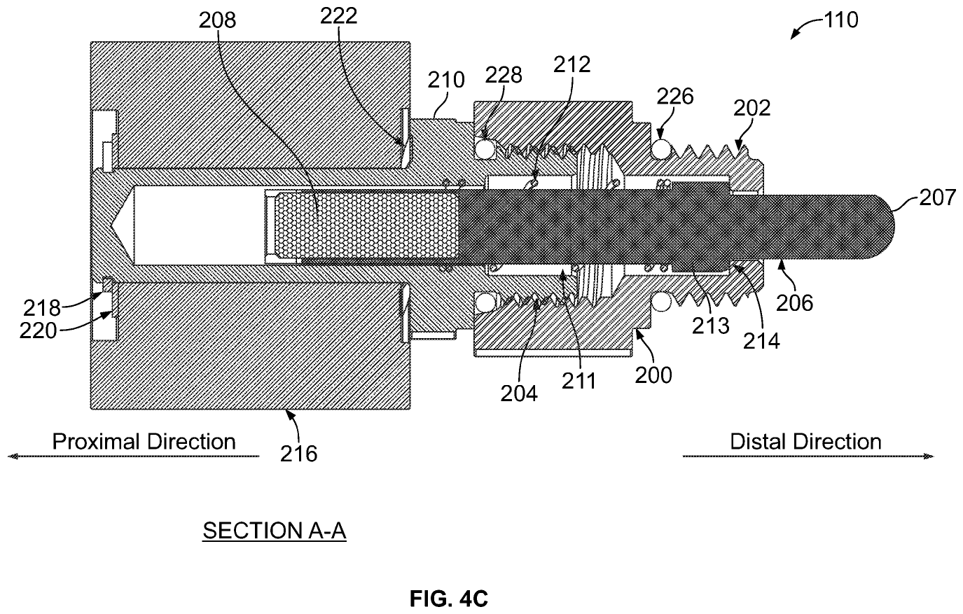

FIG. 4A illustrates a perspective view of the rotary sensor 110, FIG. 4B illustrates a top view of the rotary sensor 110, and FIG. 4C illustrates a cross-sectional view of the rotary sensor 110, according to an example implementation. FIGS. 4A-4C are described together.

The rotary sensor 110 includes an adapter 200. In an example, the adapter 200 can be configured as a hexagonal body as shown in FIG. 4A. As an example, the adapter 200 can be made of machined stainless steel. The adapter 200 includes external threads 202 (e.g., Society of Automotive Engineers (SAE)—4 male threads) formed at its distal end and configured to engage corresponding internal threads in the housing 102 of the rotary actuator 100 to mount the rotary sensor 110 to the rotary actuator 100.

The adapter 200 can also include internal threads 204 (e.g., a female SAE-4 threaded connection) at a proximal end of the adapter 200 as shown in FIG. 4C. The adapter 200 is configured to operate as a guide for a follower 206 of the rotary sensor 110. The follower 206 can also be referred to as a tracer, and is configured to move in an oscillating linear motion within the rotary sensor 110 as described in more details below.

In an example, the follower 206 can be made from an injection molded thermoplastic material (e.g., Delrin®). In one example, the follower 206 can have a tip 207 at a distal end of the follower 206. As described below, the tip 207 is configured to be in contact with a cam surface (e.g., of a cam 402 described below).

In an example, the tip 207 can be configured as a spherical tip. In this example, by being configured to have a spherical shape, the tip 207 may ensure smooth and consistent contact with the cam surface it follows. The spherical tip may also allow the follower 206 to maintain a consistent point of contact with the cam surface regardless of the orientation of the follower 206 or the position of the cam. This is because a sphere has the same curvature in all directions, which ensures that the contact point between the follower 206 and the cam surface remains constant, regardless of any small variations in the orientation of the follower 206 or the cam's position.

The follower 206 has a cavity at its proximal end, and the rotary sensor 110 includes a magnet 208 disposed in such cavity. As an example, the magnet 208 can be a rare earth magnet coupled to or retained within the cavity of the follower 206, and is configured to generate a magnetic field.

The rotary sensor 110 also includes a tube 210 configured as a magnetic tube for the rotary sensor 110. In an example, the tube 210 is a machined stainless steel component with external threads at its distal end (e.g., SAE-4 male threaded connection) configured to engage the internal threads 204 of the adapter 200 to couple the tube 210 to the adapter 200. As depicted in FIG. 4C, the tube 210 has an open distal end through which the follower 206 is disposed and a closed distal end, such that the tube 210 and the adapter 200 form a longitudinal aperture 211 in which the follower 206 can oscillate in a linear motion.

The rotary sensor 110 further includes a spring 212 (e.g., a steel spring) disposed in the longitudinal aperture 211. The spring 212 is compressed between an enlarged portion 213 (e.g., larger diameter section) of the follower 206 and an internal shoulder formed in tube 210 as depicted in FIG. 4C. With this configuration, a proximal end of the spring 212 is fixed, while a distal end of the spring 212 rests against the enlarged portion 213 of the follower 206, thereby applying a biasing force on the follower 206 in the distal direction. This way, the spring 212 ensures that the tip 207 of the follower 206 remains in contact with a surface that the follower 206 traces during operation. The stroke of the follower 206 in the distal direction is limited as the enlarged portion 213 contacts an internal shoulder 214 at the distal end of the adapter 200.

The rotary sensor 110 further includes an electronics module 216 mounted to an exterior surface of the tube 210. The electronics module 216 can also be referred to as a “read head,” and is configured to have a generally cylindrical body containing electronics that detect changes in magnetic field as the follower 206 and the magnet 208 move linearly, and thus determine the linear position of the follower 206.

For example, the electronics module 216 can include a printed circuit board (PCB) located within a molded frame, and such PCB can have electronics configured to resolve the magnetic field generated by the magnet 208 to determine the linear position of the follower 206. A PCB mechanically supports and electrically connects electronic components (e.g., microprocessors, integrated chips, capacitors, resistors, etc.) using conductive tracks, pads, and other features etched from one or more sheet layers of copper laminate onto and/or between sheet layers of a nonconductive substrate. Components are generally soldered onto the PCB to both electrically connect and mechanically fasten them to it.

In an example, the magnet 208 operates as a magnetic target for the electronics module 216, which is configured to measure changes in magnetic field intensity. As the follower 206 moves, the magnet 208 moves therewith, and the magnetic field intensity sensed or measured by the electronics module 216 changes. The position of the follower 206 to which the magnet 208 is attached can be correlated with the magnetic field intensity measured by the electronics module 216. Particularly, a processor of the electronics module 216 can receive the magnetic field intensity information as the magnet 208 moves, and can then determine the position of the follower 206 based on the magnetic field intensity information.

In an example, the electronics module 216 has one or more coils that receive electric power, and responsively generate a magnetic field, which can interact with the magnetic field of the magnet 208. As the follower 206 and the magnet 208 move, the magnetic field changes, and such change is sensed by the coils of the electronics module 216. The coils of the electronics module 216 can then generate one or more voltage signal indicative of the change in the magnetic field, which is correlated with a linear position of the follower 206.

In an example, the rotary sensor 110 can include a retaining ring 218 and a washer 220 mounted circumferentially around the tube 210 and configured to retain the electronics module 216 axially relative to the tube 210. As an example, the retaining ring 218 can be a steel snap ring mounted in a groove formed at the proximal end of the tube 210. The washer 220 can be a stainless steel flat washer used in conjunction with the retaining ring 218 to retain the electronics module 216 axially to the tube 210.

In one example, the rotary sensor 110 can include a spring 222 interposed between the electronics module 216 and the tube 210. The spring 222 is depicted as a wave spring; however, other types of biasing devices could be used. The spring 222 is configured to apply a biasing force on the electronics module 216 in the proximal direction toward the retaining ring 218 and the washer 220 to fix the electronics module 216 at a particular repeatable position relative to the follower 206 to compensate for manufacturing tolerances in the follower 206 or the electronics module 216.

The rotary sensor 110 further includes a first seal 226 (e.g., an elastomeric O-ring seal) disposed about the exterior surface of the adapter 200. The first seal 226 is configured to seal the hole in the housing 102 of the rotary actuator 100 in which the rotary sensor 110 is disposed to prevent leakage from the fluid-filled cavity within the housing 102 to an external environment of the rotary actuator 100. The rotary sensor 110 an also include a second seal 228 disposed in an annular groove formed in the tube 210 to seal the connection between the adapter 200 and the tube 210, thereby rendering the longitudinal aperture 211 a pressure tight cavity in which the follower 206 reciprocates linearly.

The follower 206 is configured to trace a cam profile within the rotary actuator 100. The cam profile provides a continuously-varying radial surface position from the central axis of rotation of the output shaft 108 of the rotary actuator 100, and thus the linear position of the follower 206 indicates the rotary position of the output shaft 108 of the rotary actuator 100.

Although the rotary sensors 110, 112 are described herein as contact-type sensors where a follower such as the follower 206 contacts a cam surface, it is contemplated herein that a non-contact sensor can be used. Such non-contact sensors can be configured to measure the position of a rotary component based on interacting with a cam surface without contacting the cam surface. For example, a rotary sensor can be an optical sensor probe having an optical disc that operates as a window overseeing a cam surface within the cavity of the housing 102.

Such optical sensor can have a source of light that emits light through the optical disc. The optical sensor can also have a sensing element that receives the light reflected from the cam surface and converts light rays into electronic signals. Particularly, the sensing element can measure the distance to the cam surface and then converts the measurement into an electric signal indicative of the distance, and thus indicative of a rotary position of the cam.

As such, the term “interacting” with the cam surface is used herein to encompass both contacting the cam surface or having no contact with the cam surface yet being configured to determine a rotational position of the cam surface. Thus, although the description below describes the rotary sensors 110, 112 being contact sensors, it should be understood that non-contact sensor can alternatively be used.

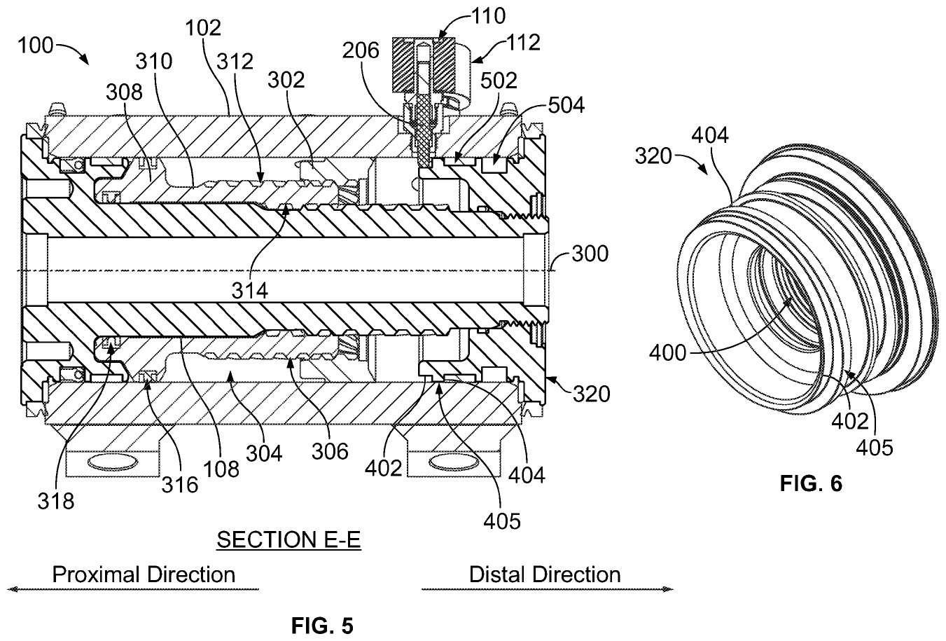

FIG. 5 illustrates a cross-sectional side view of the rotary actuator 100, according to an example implementation. The cutting plane of the cross sectional view of FIG. 5 passes through the rotary sensor 110 as shown in FIG. 3.

The rotary actuator 100 depicted in the example implementation of FIGS. 1-3, 5 is a helical rotary actuator as an example for illustration. The disclosed rotary sensor configuration and operation can be used with other types of fluid-based rotary actuators.

The housing 102 of the rotary actuator 100 is a generally cylindrical body having a longitudinal axis 300. The output shaft 108 of the rotary actuator 100 is coaxial with the housing 102 and is configured to rotate about the longitudinal axis 300.

The housing 102 has an internal ring 302 projecting radially inward inside a cavity 304 within the housing 102. The internal ring 302 can be referred to as a ring gear and has helical splines projecting radially inward within the cavity 304. The internal ring 302 can be welded, for example, to an internal surface of the housing 102.

The rotary actuator 100 further includes an annular piston 306 (hollow piston) mounted in the cavity 304 around the output shaft 108. In other words, the annular piston 306 encircles the output shaft 108, and is radially interposed between the output shaft 108 and the interior surface of the housing 102. The annular piston 306 has a piston head 308 and a piston rod 310.

The annular piston 306 has external helical splines 312 projecting radially-outward from the piston rod 310 and configured to engage with the internal helical splines of the internal ring 302 of the housing 102. The annular piston 306 also has internal helical splines 314 projecting radially-inward into a longitudinal cavity of the annular piston 306, and the internal helical splines 314 are configured to engage with external helical splines formed in the output shaft 108.

Referring to FIGS. 1-2, 5 together, when fluid is provided to the first port 104 of the rotary actuator 100, fluid flows to within the cavity 304 and applies a fluid force on the annular piston 306 in a proximal axial direction (e.g., to the left in FIG. 5). The fluid force causes the annular piston 306 to move longitudinally (along the longitudinal axis 300) in the proximal axial direction.

Due to the engagement of the external helical splines 312 of the annular piston 306 with the internal helical splines of the internal ring 302 (which is fixed), the annular piston 306 rotates as it translates linearly in the proximal direction. Further, due to engagement of the internal helical splines 314 of the annular piston 306 with the external helical splines of the output shaft 108, as the annular piston 306 moves linearly in the proximal direction and rotates, the output shaft 108 rotates therewith in a first rotational direction. As the annular piston 306 moves, fluid is discharged from the other side of the piston head 308 through the second port 106.

Conversely, when fluid is provided to the second port 106 of the rotary actuator 100, fluid flows to within the cavity 304 and applies a respective fluid force on the annular piston 306 in a distal axial direction (e.g., to the right in FIG. 5). The respective fluid force causes the annular piston 306 to move longitudinally in the distal axial direction.

Due to the engagement of the external helical splines 312 of the annular piston 306 with the internal helical splines of the internal ring 302 (which is fixed), the annular piston 306 rotates as it translates linearly. Further, due to engagement of the internal helical splines 314 of the annular piston 306 with the external helical splines of the output shaft 108, as the annular piston 306 moves linearly in the distal direction and rotates, the output shaft 108 rotates therewith in a second rotational direction (opposite the first rotational direction). As the annular piston 306 moves, fluid is discharged from the other side of the piston head 308 through the first port 104.

The annular piston 306 has an external groove in the piston head 308 in which a seal 316 is disposed to seal against the interior surface of the housing 102. The annular piston 306 also has an internal groove in which a seal 318 is disposed to seal against the exterior surface of the output shaft 108. The seals 316, 318 prevent leakage or cross flow between the chambers formed in the cavity 304 on both sides of the piston head 308.

As such, reciprocal longitudinal movement of the annular piston 306 within the housing 102, in response to the selective application of fluid on either side of the annular piston 306, cause the output shaft 108 to rotate clockwise or counterclockwise relative to the housing 102. The speed of rotation of the output shaft 108 can depend on the pitch of the helical splines of the annular piston 306, for example.

The rotary actuator 100 further includes an end cap 320 mounted at a distal end of the housing 102 and coupled to the output shaft 108 such that rotation of the output shaft 108 causes the end cap 320 to rotate therewith. The rotary sensor 110 is configured to detect rotational position of the end cap 320.

FIG. 6 illustrates a perspective view of the end cap 320, according to an example implementation. The end cap 320 can be coupled to the output shaft 108 in various ways. For example, the end cap 320 can have internal threads 400 configured to engage with corresponding external threads of the output shaft 108 to rotatably couple the end cap 320 to the output shaft 108. However, other ways (e.g., key-keyway arrangement, spline arrangement, self-holding taper arrangement) could be used.

The end cap 320 has a cam 402. As depicted in FIG. 5, the follower 206 of the rotary sensor 110 is configured to be in contact with the exterior surface of the cam 402. The follower 206 maintains contact with the cam 402 during rotation of the output shaft 108 and the end cap 320. However, as mentioned above, if a non-contact sensor is used, a sensing element of such sensor can interact with the cam 402 to determine its position without contact.

In an example, the cam 402 can be configured to include as an eccentric cylinder portion (e.g., lobe) offset radially from the longitudinal axis 300 (axis of rotation of the output shaft 108) to provide a continuously-varied radial surface position from the longitudinal axis 300 during rotary motion of the output shaft 108 and the end cap 320. With this configuration, as the end cap 320 rotates, rotary motion of the end cap 320 and the cam 402 translates into a reciprocal movement of the follower 206 of the rotary sensor 110.

The configuration of the cam 402 is described herein as an example for illustration only. Any configuration that provides a continuously varied radial surface position from the longitudinal axis 300 of rotation of the output shaft 108 during rotation is contemplated herein. Also, interacting with such configuration can be contact-based interaction or non-contact-based interaction (e.g., via optical signals).

In the examples where the rotary sensor 112 (the secondary, reference sensor) is used, the end cap 320 can have a flange 404 (e.g., a projecting rim) that is concentric with the output shaft 108. As described in more detail below, a circular surface 405 of the flange 404 operates as a reference surface that can render measurements of the rotary sensor 110 (the primary sensor) more accurate.

Referring to FIGS. 4C, 5 together, the spring 212 causes the follower 206 (and particularly the tip 207 thereof) of the rotary sensor 110 to maintain contact with the cam 402 of the end cap 320. As the cam 402 rotates through its range of rotational movement, the linear position of the follower 206 continuously changes as it traces the exterior surface of the cam 402 due to the continuously varied radial distance between the center of rotation (the longitudinal axis 300) of the output shaft 108 and the exterior surface of the cam 402.

As such, the rotary sensor 110, and particularly the electronics module 216, can provide sensor information indicative of the linear position of the follower 206, which is in turn indicative of the rotational position of the output shaft 108. In other words, the rotary position of the cam 402 (and thus of the end cap 320 and the output shaft 108) can be derived from the linear position of the follower 206 as determined by the electronics module 216.

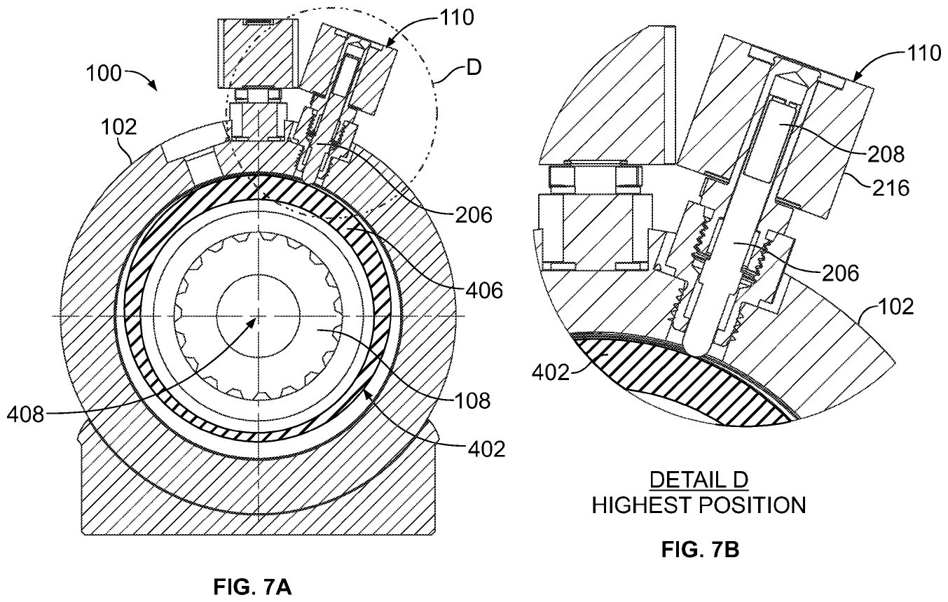

FIG. 7A illustrates a cross-sectional front view of the rotary actuator 100 when the follower 206 is at the highest position, and FIG. 7B illustrates a detailed view of the cross section of FIG. 7A, according to an example implementation. The cutting plane of the cross section of FIG. 7A is labelled in FIG. 2. FIG. 7B provides an enlarged view of the rotary sensor 110 and the cam 402 when the follower 206 is at the highest position.

As shown, the cam 402 has a lobe 406, e.g., a protrusion or bump on the surface of the cam 402 that is designed to push the follower 206. In other words, the lobe 406 is a raised feature that translates the rotational motion of the cam 402 into the linear motion of the follower 206. The shape and size of the lobe 406 may determine the characteristics of the linear movement of the follower 206.

At the rotary position of the cam 402 shown in FIGS. 7A-7B, the lobe 406 is at a rotational position that causes the follower 206 to be retracted fully within the rotary sensor 110. As such, the follower 206 and the magnet 208 are at the highest position radially relative to a center 408 of the output shaft 108 (i.e., relative to the longitudinal axis 300). In other words, the follower 206 and the magnet 208 have moved farthest from the center 408 in a radially-outward direction.

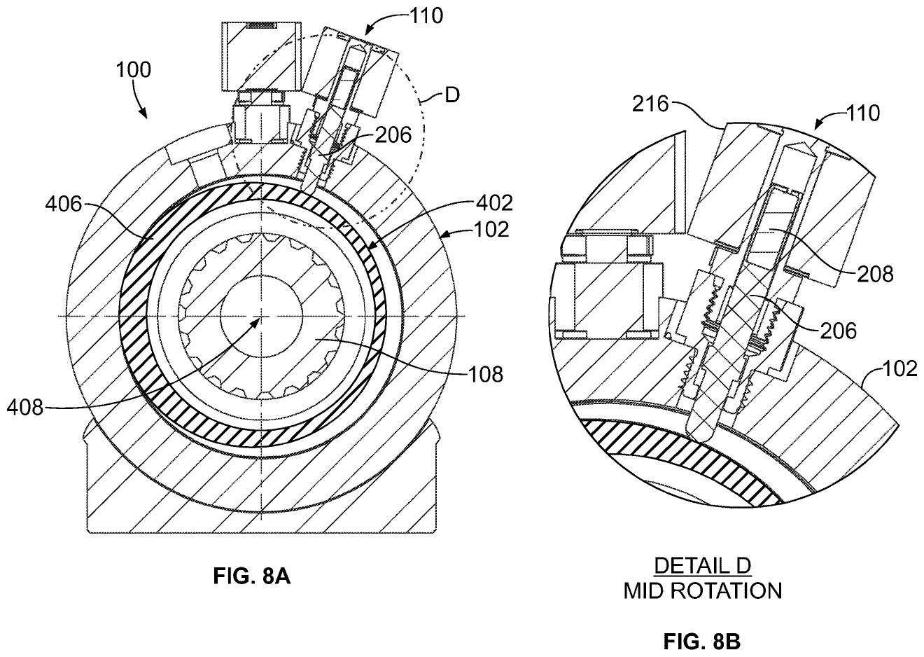

FIG. 8A illustrates a cross-sectional front view of the rotary actuator 100 when the follower 206 is at a mid-rotation position, and FIG. 8B illustrates a detailed view of the cross section of FIG. 8A, according to an example implementation. The cutting plane of the cross section of FIG. 8A is the same as that of FIG. 7A and is labelled in FIG. 2. FIG. 8B provides an enlarged view of the rotary sensor 110 and the cam 402 when the cam 402 is at the mid-rotation position (i.e., when the follower 206 is at the middle of its stroke).

At the mid-rotation rotary position of the cam 402 shown in FIGS. 8A-8B, the lobe 406 (e.g., the rise portion of the cam 402) has rotated counterclockwise (e.g., by 90 degrees) relative to its position in FIG. 7A, such that the highest point of the lobe 406 no longer interfaces with the follower 206. Rather, a less raised portion (e.g., the return portion of the cam profile) now interfaces with the follower 206, and the spring 212 of the rotary sensor 110 pushes the follower 206 downward into the cavity 304 within the housing 102 as the follower 206 traces the surface of the cam 402. As such, the follower 206 and the magnet 208 are at the mid-stroke position, and has moved radially inward toward the center 408 of the output shaft 108 (i.e., relative to the longitudinal axis 300).

As the cam 402 keeps rotating, the follower 206 correspondingly moves linearly. The electronics module 216 determines the linear position of the follower 206, which is indicative of the rotational position of the cam 402 and the output shaft 108.

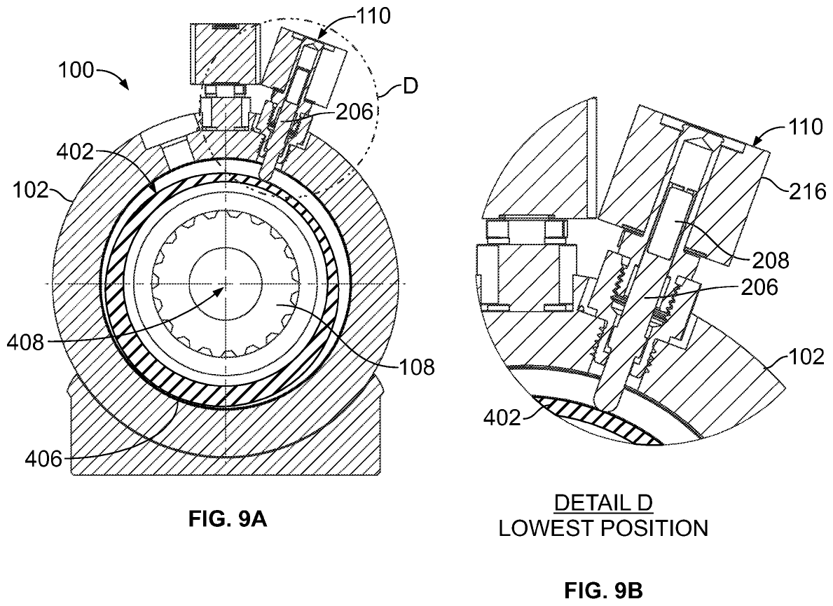

FIG. 9A illustrates a cross-sectional front view of the rotary actuator 100 when the follower 206 is at the lowest position, and FIG. 9B illustrates a detailed view of the cross section of FIG. 9A, according to an example implementation. The cutting plane of the cross section of FIG. 9A is the same as that of FIG. 7A and is labelled in FIG. 2. FIG. 9B provides an enlarged view of the rotary sensor 110 and the cam 402 when the follower 206 is at the lowest position.

As shown, the cam 402 has rotated further in the counterclockwise direction (e.g., by 180 degrees relative to its position in FIG. 7A), and the lobe 406 is now diametrically opposite from the location of the follower 206. As such, the follower 206 extends downward the farthest into the cavity 304 within the housing 102.

At the rotary position of the cam 402 shown in FIGS. 9A-9B, the follower 206 is fully extended within the rotary sensor 110. As such, the follower 206 and the magnet 208 are at the lowest position relative to the center 408 of the output shaft 108 (i.e., relative to the longitudinal axis 300). In other words, the follower 206 and the magnet 208 have moved closest to the center 408.

The three positions shown in FIGS. 7A, 8A, 9A are provided as examples of positions that the follower 206 goes through. During rotation of the output shaft 108 and the cam 402, the linear position of the follower 206 continually changes as it traces the exterior surface of the cam 402.

As an example for illustration, the rotary sensor 110 can be configured such that the total stroke of the follower 206 (e.g., the total axial motion of the follower 206 between the highest position of FIGS. 7A-7B, and the lowest position of FIGS. 9A-9B) is about 0.18 inches, which corresponds to 180 degrees of rotation of the cam 402. The electronics module 216 can be configured to detect motions as small as one tenth of one thousandth of an inch (0.0001 inches). In this example, the electronics module 216 can determine the rotational position of the cam 402 and the output shaft 108 to an accuracy of 0.1 degrees.

In some examples, due to manufacturing tolerances, the assembly of the output shaft 108, the annular piston 306, and the end cap 320 may be offset from a center of the housing 102. As an example, there might be a clearance (e.g., 0.005-0.008 inches) between an exterior surface of the end cap 320 (and an exterior surface of the piston head 308) and the interior surface of the housing 102). As such, there may be some radial “play” or movement in the assembly of the output shaft 108, the annular piston 306, and the end cap 320 within the cavity 304 of the housing 102.

In these examples, such radial play may cause the position of the follower 206 to provide an inaccurate indication of the rotational position of the output shaft 108. For instance, if the assembly is shifted downward in the cavity 304, the follower 206 might extend into the cavity 304, which could indicate inaccurately or falsely that the cam 402 has rotated.

In another example, due to high fluid pressures in the cavity 304 (e.g., pressure levels up to 5000 psi), the components of the rotary actuator 100, such as the housing 102, the end cap 320, or the annular piston 306, might be distorted. For instance, the interior surface of the housing 102 might not remain circular under high pressures. Such distortions might also affect accuracy of the rotary sensor 110 in indicating the rotary position of the output shaft 108.

In these examples, it may be desirable to configure the rotary actuator 100 to have the rotary sensor 112 to operate as a reference sensor that provides a benchmark or reference value for where the internal assembly of the rotary actuator 100 is. Such reference value might then be subtracted from the measurement of the rotary sensor 110 to nullify the effect of any radial play or distortion.

As shown in FIGS. 1, 3, in an example, the rotary sensor 112 is angularly spaced from the rotary sensor 110 about a surface of the housing 102. For instance, the rotary sensor 112 can be angularly spaced from the rotary sensor 110 by less than 30 degrees.

Also, the rotary sensor 112 is offset axially or longitudinally from the rotary sensor 110 along a length of the housing 102 as shown in FIGS. 1-2. For instance, the rotary sensor 112 can be axially offset from the rotary sensor 110 by a distance less than a diameter of the electronics module 216 of the rotary sensor 110 or the rotary sensor 112.

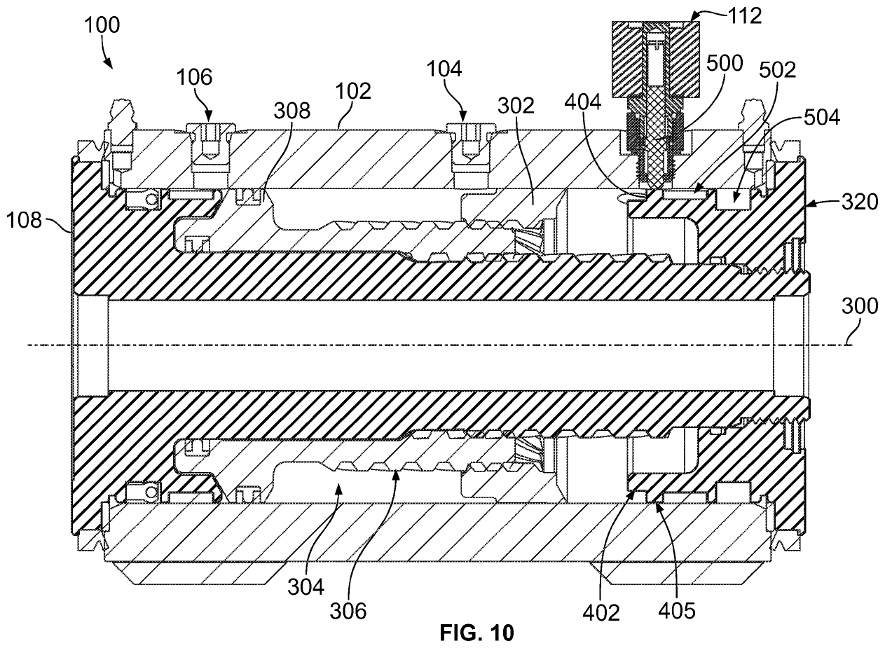

FIG. 10 illustrates another cross-sectional side view of the rotary actuator 100, according to an example implementation. The cutting plane of the cross sectional view of FIG. 10 passes through the rotary sensor 112 as shown in FIG. 3.

As mentioned above, in addition to the cam 402, the end cap 320 includes the flange 404 having the circular surface 405. The circular surface 405 is coaxial or concentric with the center of rotation (e.g., the center 408) of the output shaft 108. As such, the circular surface 405 has a constant radius, and points on the circular surface 405 are equidistant from the center 408 of the output shaft 108.

The rotary sensor 112 can be configured similar to the rotary sensor 110, and may have a follower 500 that contacts the circular surface 405. As such, the rotary sensor 112 can measure and provide respective sensor information indicative of a location of the circular surface 405, which is concentric with the output shaft 108. It should be understood that a non-contact sensor can alternatively be used.

The circular surface 405 provides a baseline surface to measure via the rotary sensor 112. Such measurement can then be used to modify the measurement by the rotary sensor 110 so that movement of the cam 402 of the end cap 320 resulting from radial play or distortion is nullified.

Particularly, in an example, the measurement or position of the circular surface 405 as detected by the follower 500 of the rotary sensor 112 can be subtracted from the measurement of the position of the follower 206 of the rotary sensor 110 to eliminate any inaccuracies resulting from unintended movement of the end cap 320 (e.g., radial play). Elimination of such extraneous radial motion (when the end cap 320 is subjected to radial deflection relative to the housing 102 from component assembly clearances or under heavy external loading) may produce a more accurate and repeatable angular position resolution for the output shaft 108 as determined by the rotary sensor 110.

Advantageously, as shown in FIG. 10, the circular surface 405 is located immediately adjacent to the cam 402. Such closeness between the cam 402 traced by the follower 206 of the rotary sensor 110 and the circular surface 405 traced by the follower 500 of the rotary sensor 112 may render the determination of the rotary position of the output shaft 108 after nullification of any radial play or distortion more accurate. In particular, having the cam 402 immediately adjacent to the circular surface 405 and having both of them permanently fixed to the end cap 320 allows a subtraction to be instantaneously performed on output values of the rotary sensor 110 such that all positional variance of the end cap 320 with respect to the housing 102 is nullified.

As shown in FIGS. 5, 10, the end cap 320 includes a first annular groove 502 adjacent the circular surface 405 and a second annular groove 504 that is axially spaced from the first annular groove 502. The rotary actuator 100 can include a bearing (e.g., a radial ball bearing or a bushing) disposed in the first annular groove 502 to facilitate rotation of the end cap 320 relative to the housing 102.

The rotary actuator 100 can further include a rotary pressure seal disposed in the second annular groove 504 to seal the pressure cavity within the housing 102 from an external environment of the rotary actuator 100. Such rotary pressure seal can be configured to creating a seal around the end cap 320 as it rotates. With the configuration shown in FIGS. 5, 10, the rotary sensors 110, 112 are subjected to high pressure fluid as the rotary pressure seal in the second annular groove 504 is disposed distal from the rotary sensors 110, 112. It is desirable to not subject the rotary sensors 110, 112 to the high pressure fluid, the end cap can be reconfigured to have the rotary pressure seal proximal from the rotary sensors 110, 112.

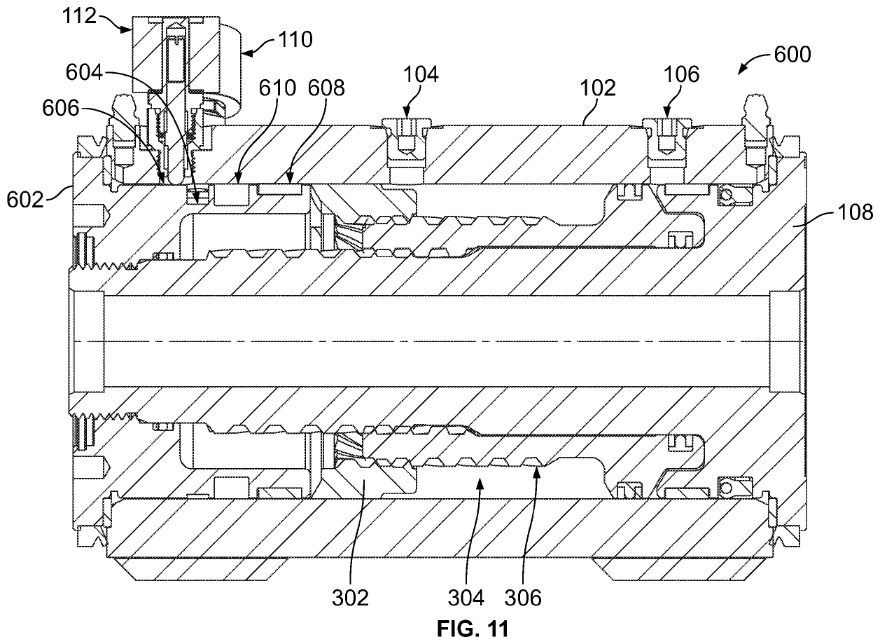

FIG. 11 illustrates a cross-sectional side view of a rotary actuator 600, according to an example implementation. The rotary actuator 600 is similar to the rotary actuator 100, and identical components are designated with the same reference numbers.

The rotary actuator 600 includes an end cap 602 that differs from the end cap 320 in that the end cap 602 has cam 604 (similar to the cam 402) and a circular surface 606 (similar to the circular surface 405) that are distal from a first annular groove 608 in which a bearing is disposed and a second annular groove 610 in which a rotary pressure seal is disposed. With this configuration, the rotary pressure seal in the second annular groove 610 isolates the rotary sensor 110, 112 from high pressure fluid in the cavity 304.

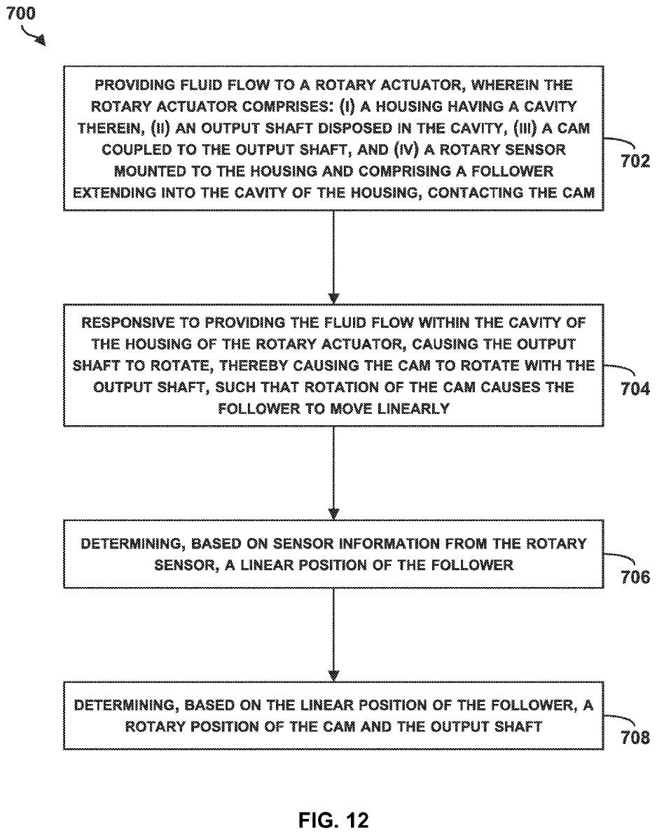

FIG. 12 is a flowchart of a method 700 for operating the rotary actuator 100, 600, according to an example implementation. The method 700 may include one or more operations, or actions as illustrated by one or more of blocks 702-708. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for the method 700 and other processes and operations disclosed herein, the flowchart shows operation of one possible implementation of present examples. In this regard, some blocks may represent a module, a segment, or a portion of program code, which includes one or more instructions executable by a processor (e.g., a processor of the rotary sensor 110 or an external controller such as the controller 114) for implementing specific logical operations or steps in the process. The program code may be stored on any type of computer readable medium or memory, for example, such as a storage device including a disk or hard drive. The computer readable medium may include a non-transitory computer readable medium or memory, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example. In addition, for the method 700 and other processes and operations disclosed herein, one or more blocks in FIG. 12 may represent circuitry or digital logic that is arranged to perform the specific logical operations in the process.

At block 702, the method 700 includes providing fluid flow to the rotary actuator 100, wherein the rotary actuator 100 comprises: (i) the housing 102 having the cavity 304 therein, (ii) the output shaft 108 disposed in the cavity 304, (iii) the cam 402, 604 coupled to the output shaft 108, and (iv) the rotary sensor 110 mounted to the housing 102 and comprising the follower 206 extending into the cavity 304 of the housing 102, contacting the cam 402, 604.

At block 704, the method 700 includes, responsive to providing the fluid flow within the cavity 304 of the housing 102 of the rotary actuator 100, causing the output shaft 108 to rotate, thereby causing the cam 402, 604 to rotate with the output shaft 108, such that rotation of the cam 402, 604 causes the follower 206 to move linearly.

At block 706, the method 700 includes determining, based on sensor information from the rotary sensor 110, a linear position of the follower 206. For example, the electronics module 216 may determine the linear position of the follower 206 based on the sensor information, or may provide the sensor information to an external controller (e.g., the controller 114), and such controller determines the linear position.

At block 708, the method 700 includes determining, based on the linear position of the follower, a rotary position of the cam 402, 604 and the output shaft 108.

The method 700 can further any of the operations described throughout herein. For example, the rotary actuator 100 can further include the circular surface 405 that is concentric with the output shaft 108, and the rotary sensor 112 mounted to the housing and comprising the follower 500 extending into the cavity 304 of the housing 102, contacting the circular surface 405. The method can include determining, based on respective sensor information from the rotary sensor 112, a respective linear position of the follower 500; and adjusting the rotary position of the cam 402 and the output shaft 108 based on the respective linear position of the follower 500. Adjusting the rotary position of the cam 402 and the output shaft 108 can be based on subtracting the respective linear position of the follower 500 from the linear position of the follower 206, for example.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiment (EEEs) listed below.

EEE 1 is a rotary actuator comprising: a housing having a cavity therein; an output shaft disposed in the cavity and configured to rotate within the housing upon providing fluid flow within the housing; a cam coupled to the output shaft and configured to rotate therewith; and a rotary sensor mounted to the housing, wherein the rotary sensor interacts with the cam such that the rotary sensor provides sensor information indicating a rotary position of the cam and the output shaft.

EEE 2 is the rotary actuator of EEE 1, wherein the rotary sensor includes a follower extending into the cavity of the housing, contacting the cam to trace a surface of the cam, such that rotation of the cam causes the follower to move linearly, wherein the rotary sensor is configured to provide sensor information indicating a linear position of the follower, thereby indicating the rotary position of the cam and the output shaft.

EEE 3 is the rotary actuator of EEE 2, wherein the cam comprises a lobe that is offset radially from a longitudinal axis of the output shaft such that the surface of the cam that the follower traces has a continuously-varied position from the longitudinal axis as the output shaft rotates about the longitudinal axis.

EEE 4 is the rotary actuator of any of EEEs 1-3, wherein the rotary sensor is a first rotary sensor, and wherein the rotary actuator further comprises: a circular surface that is concentric with the output shaft; and a second rotary sensor mounted to the housing, wherein the second rotary sensor interacts with the circular surface such that the second rotary sensor provides respective sensor information indicative of a location of the circular surface, and wherein the respective sensor information of the second rotary sensor is used to modify the sensor information of the first rotary sensor to determine the rotary position of the cam and the output shaft.

EEE 5 is the rotary actuator of EEE 4, wherein: the first rotary sensor includes a first follower extending into the cavity of the housing, contacting the cam to trace a surface of the cam such that rotation of the cam causes the first follower to move linearly, wherein the rotary sensor is configured to provide sensor information indicating a linear position of the first follower, thereby indicating the rotary position of the cam and the output shaft, and the second rotary sensor includes a second follower extending into the cavity of the housing, contacting the circular surface, wherein the respective sensor information is indicative of a respective linear position of the second follower, thereby indicating the location of the circular surface.

EEE 6 is the rotary actuator of any of EEEs 4-5, wherein the second rotary sensor is angularly spaced from the first rotary sensor about a surface of the housing.

EEE 7 is the rotary actuator of any of EEEs 4-6, wherein the second rotary sensor is axially offset from the first rotary sensor along a length of the housing.

EEE 8 is the rotary actuator of any of EEEs 4-7, further comprising: an end cap mounted to the output shaft and configured to rotate therewith, wherein the end cap comprises the cam and the circular surface, such that the circular surface is adjacent to the cam.

EEE 9 is the rotary actuator of any of EEEs 1-8, further comprising: an annular piston mounted to the output shaft such that fluid provided within the cavity of the housing applies a fluid force on the annular piston, causing the annular piston to move linearly within the cavity, thereby rotating the output shaft.

EEE 10 is the rotary actuator of EEE 9, wherein the housing comprises an internal ring having internal helical splines, wherein the annular piston comprises external helical splines engaging with the internal helical splines of the internal ring of the housing such that linear movement of the annular piston causes the annular piston to rotate relative to the housing.

EEE 11 is the rotary actuator of EEE 10, wherein the annular piston further comprises respective internal helical splines engaging with respective external helical splines formed in the output shaft, such that rotation of the annular piston causes the output shaft to rotate relative to the housing.

EEE 12 is the rotary actuator of EEE 11, further comprising: a first port formed in the housing; and a second port formed in the housing axially spaced from the first port along a length of the housing, wherein providing fluid through the first port to the cavity causes the annular piston to move in a first axial direction, causing the output shaft to rotate in a first rotational direction, and wherein providing fluid through the second port to the cavity causes the annular piston to move in a second axial direction, causing the output shaft to rotate in a second rotational direction, opposite the first rotational direction.

EEE 13 is the rotary actuator of any of EEEs 1-12, further comprising: an end cap mounted to the output shaft and configured to rotate therewith, wherein the end cap comprises: (i) the cam, (ii) a first annular groove in which a bearing is disposed to facilitate rotation of the end cap, and (iii) a second annular groove in which a rotary pressure seal is disposed.

EEE 14 is the rotary actuator of EEE 13, wherein the rotary pressure seal is disposed distal from the rotary sensor such that the rotary sensor is subjected to high pressure fluid in the cavity of the housing.

EEE 15 is the rotary actuator of EEE 13, wherein the rotary pressure seal is disposed proximal from the rotary sensor such that the rotary sensor is isolated from high pressure fluid in the cavity of the housing.

EEE 16 is the rotary actuator of any of EEEs 1-15, wherein the rotary sensor comprises: an adapter configured to facilitate mounting the rotary sensor to the housing; a follower extending into the cavity of the housing, contacting the cam to trace a surface of the cam; and a tube coupled to the adapter and forming a longitudinal aperture with the adapter, such that the follower oscillates linearly in the longitudinal aperture as the cam rotates.

EEE 17 is the rotary actuator of EEE 16, wherein the rotary sensor further comprises: a spring mounted in the longitudinal aperture and configured to bias the follower toward the cam to maintain contact therebetween as the cam rotates with the output shaft.

EEE 18 is the rotary actuator of any of EEEs 16-17, wherein the rotary sensor comprises: a magnet mounted to the follower and movable therewith; and an electronics module mounted to the tube and configured to detect a linear position of the follower and the magnet.

EEE 19 is the rotary actuator of EEE 18, wherein the rotary sensor comprises: a retaining ring mounted to the tube and retaining the electronics module axially to the tube; and a spring interposed between the tube and the electronics module and applying a biasing force on the electronics module toward the retaining ring to fix the electronics module at a particular position relative to the follower.

EEE 20 is a method of operating the rotary actuator of any of EEEs 1-19. For example, the method comprises: providing fluid flow to a rotary actuator, wherein the rotary actuator comprises: (i) a housing having a cavity therein, (ii) an output shaft disposed in the cavity, (iii) a cam coupled to the output shaft, and (iv) a rotary sensor mounted to the housing and comprising a follower extending into the cavity of the housing, contacting the cam; responsive to providing the fluid flow within the cavity of the housing of the rotary actuator, causing the output shaft to rotate, thereby causing the cam to rotate with the output shaft, such that rotation of the cam causes the follower to move linearly; determining, based on sensor information from the rotary sensor, a linear position of the follower; and determining, based on the linear position of the follower, a rotary position of the cam and the output shaft.

What is claimed is:

1. A rotary actuator comprising:
a housing having a cavity therein;
an output shaft disposed in the cavity and configured to rotate within the housing upon providing fluid flow within the housing;
a cam coupled to the output shaft and configured to rotate therewith; and
a rotary sensor mounted to the housing, wherein the rotary sensor interacts with the cam such that the rotary sensor provides sensor information indicating a rotary position of the cam and the output shaft.

2. The rotary actuator of claim 1, wherein the rotary sensor includes a follower extending into the cavity of the housing, contacting the cam to trace a surface of the cam, such that rotation of the cam causes the follower to move linearly, wherein the rotary sensor is configured to provide sensor information indicating a linear position of the follower, thereby indicating the rotary position of the cam and the output shaft.

3. The rotary actuator of claim 2, wherein the cam comprises a lobe that is offset radially from a longitudinal axis of the output shaft such that the surface of the cam that the follower traces has a continuously-varied position from the longitudinal axis as the output shaft rotates about the longitudinal axis.

4. The rotary actuator of claim 1, wherein the rotary sensor is a first rotary sensor, and wherein the rotary actuator further comprises:
a circular surface that is concentric with the output shaft; and
a second rotary sensor mounted to the housing, wherein the second rotary sensor interacts with the circular surface such that the second rotary sensor provides respective sensor information indicative of a location of the circular surface, and wherein the respective sensor information of the second rotary sensor is used to modify the sensor information of the first rotary sensor to determine the rotary position of the cam and the output shaft.

5. The rotary actuator of claim 4, wherein:
the first rotary sensor includes a first follower extending into the cavity of the housing, contacting the cam to trace a surface of the cam such that rotation of the cam causes the first follower to move linearly, wherein the rotary sensor is configured to provide sensor information indicating a linear position of the first follower, thereby indicating the rotary position of the cam and the output shaft, and
the second rotary sensor includes a second follower extending into the cavity of the housing, contacting the circular surface, wherein the respective sensor information is indicative of a respective linear position of the second follower, thereby indicating the location of the circular surface.

6. The rotary actuator of claim 4, wherein the second rotary sensor is angularly spaced from the first rotary sensor about a surface of the housing.

7. The rotary actuator of claim 4, wherein the second rotary sensor is axially offset from the first rotary sensor along a length of the housing.

8. The rotary actuator of claim 4, further comprising:
an end cap mounted to the output shaft and configured to rotate therewith, wherein the end cap comprises the cam and the circular surface, such that the circular surface is adjacent to the cam.

9. The rotary actuator of claim 1, further comprising:
an annular piston mounted to the output shaft such that fluid provided within the cavity of the housing applies a fluid force on the annular piston, causing the annular piston to move linearly within the cavity, thereby rotating the output shaft.

10. The rotary actuator of claim 9, wherein the housing comprises an internal ring having internal helical splines, wherein the annular piston comprises external helical splines engaging with the internal helical splines of the internal ring of the housing such that linear movement of the annular piston causes the annular piston to rotate relative to the housing.

11. The rotary actuator of claim 10, wherein the annular piston further comprises respective internal helical splines engaging with respective external helical splines formed in the output shaft, such that rotation of the annular piston causes the output shaft to rotate relative to the housing.

12. The rotary actuator of claim 11, further comprising:
a first port formed in the housing; and
a second port formed in the housing axially spaced from the first port along a length of the housing, wherein providing fluid through the first port to the cavity causes the annular piston to move in a first axial direction, causing the output shaft to rotate in a first rotational direction, and wherein providing fluid through the second port to the cavity causes the annular piston to move in a second axial direction, causing the output shaft to rotate in a second rotational direction, opposite the first rotational direction.

13. The rotary actuator of claim 1, further comprising:
an end cap mounted to the output shaft and configured to rotate therewith, wherein the end cap comprises: (i) the cam, (ii) a first annular groove in which a bearing is disposed to facilitate rotation of the end cap, and (iii) a second annular groove in which a rotary pressure seal is disposed.

14. The rotary actuator of claim 13, wherein the rotary pressure seal is disposed distal from the rotary sensor such that the rotary sensor is subjected to high pressure fluid in the cavity of the housing.

15. The rotary actuator of claim 13, wherein the rotary pressure seal is disposed proximal from the rotary sensor such that the rotary sensor is isolated from high pressure fluid in the cavity of the housing.

16. The rotary actuator of claim 1, wherein the rotary sensor comprises:
an adapter configured to facilitate mounting the rotary sensor to the housing;
a follower extending into the cavity of the housing, contacting the cam to trace a surface of the cam; and
a tube coupled to the adapter and forming a longitudinal aperture with the adapter, such that the follower oscillates linearly in the longitudinal aperture as the cam rotates.

17. The rotary actuator of claim 16, wherein the rotary sensor further comprises:
a spring mounted in the longitudinal aperture and configured to bias the follower toward the cam to maintain contact therebetween as the cam rotates with the output shaft.

18. The rotary actuator of claim 16, wherein the rotary sensor comprises:
a magnet mounted to the follower and movable therewith; and
an electronics module mounted to the tube and configured to detect a linear position of the follower and the magnet.

19. The rotary actuator of claim 18, wherein the rotary sensor comprises:
a retaining ring mounted to the tube and retaining the electronics module axially to the tube; and
a spring interposed between the tube and the electronics module and applying a biasing force on the electronics module toward the retaining ring to fix the electronics module at a particular position relative to the follower.

20. A method comprising:
providing fluid flow to a rotary actuator, wherein the rotary actuator comprises: (i) a housing having a cavity therein, (ii) an output shaft disposed in the cavity, (iii) a cam coupled to the output shaft, and (iv) a rotary sensor mounted to the housing and comprising a follower extending into the cavity of the housing, contacting the cam;
responsive to providing the fluid flow within the cavity of the housing of the rotary actuator, causing the output shaft to rotate, thereby causing the cam to rotate with the output shaft, such that rotation of the cam causes the follower to move linearly;
determining, based on sensor information from the rotary sensor, a linear position of the follower; and
determining, based on the linear position of the follower, a rotary position of the cam and the output shaft.
